(19) United States
(12) Patent Application Publication
(10) Pub. No.: US 2014/0071442 A1
(43) Pub. Date: Mar. 13, 2014

(54) OPTICAL SURFACE DEFECT INSPECTION APPARATUS AND OPTICAL SURFACE DEFECT INSPECTION METHOD

(71) Applicant: Hitachi High-Technologies Corporation, Tokyo (JP)

(72) Inventors: Shigeru SERIKAWA, Kamisato-machi (JP); Kiyotaka HORIE, Kamisato-machi (JP); Yu YANAKA, Kamisato-machi (JP); Farizbin ABDULRASHID, Kamisato-machi (JP)

(73) Assignee: HITACHI HIGH-TECHNOLOGIES CORPORATION, Tokyo (JP)

(21) Appl. No.: 13/968,691

(22) Filed: Aug. 16, 2013

(30) Foreign Application Priority Data
Sep. 11, 2012 (JP) 2012-199593

(51) Int. Cl. G01N 21/956; G01N 21/95

(52) U.S. Cl. CPC G01N 21/956; G01N 21/9501
USPC 356/237.2

(57) ABSTRACT

Arrangements classifying or inspecting finely classified defects. When irradiating a subject with light; focusing a scattered light from a subject surface onto plural optical receivers; and inspecting for a defect based on outputs from the optical receivers. Performed are: creating a reference matrix recipe with respect to each defect, the recipe provided with plural feature items indicative of features of the defect on one axis of the matrix and optical items including a range of detected value levels of plural detecting optical systems with respect to the feature items on the other axis, and the recipe having information defining the defect at a plurality of points in the matrix; and determining a type of the defect by creating a work matrix recipe corresponding to the reference matrix recipe based on the output from the plurality of detectors and comparing the work matrix recipe with the reference matrix recipe.

### BACKGROUND OF THE INVENTION

1. Field of the Invention

The present invention relates to an optical surface defect inspection apparatus and an optical surface defect inspection method, and specifically to the optical surface defect inspection apparatus and the optical surface defect inspection method suitable for adaptation to change and segmentation of defect types.

2. Description of the Related Art

Both a high-speed inspection applicable to 100% full inspection and a highly sensitive inspection (to detect a microdefect a few tens of nm wide and a few nm deep) are required for an optical surface defect inspection apparatus that inspects for a microdefect on a surface of a subject such as a magnetic disk, an IC wafer, and the like.

One such conventional technique is described in Patent Document 1(Japanese Patent Laid-Open 2012-042375). In the method described in Patent Document 1, as shown in FIG. 12, a defect is found from the table of the output of the optical detection system on the vertical axis and the defect types on the horizontal axis. Alternatively, the defect type may be determined using a complex determination flow as shown in FIG. 13.

### SUMMARY OF THE INVENTION

However, there is lately a demand for classifying new defects or inspecting more finely classified defects.

The method described in Patent Document 1 inspects for a microdefect on a surface of a subject setting thresholds based on a predetermined algorithm for discriminating each type of defect. Although the method described in Patent Document 1 is capable of the 100% full inspection and suitable for performing a high-speed and high-sensitive inspection, the inspection method itself is not allowed for much freedom and cannot cope with the demand for classifying new defects or inspecting more finely classified defects.

Accordingly, the present invention aims to provide an optical surface defect inspection apparatus or an optical surface defect inspection method capable of classifying new defects or inspecting more finely classified defects.

In order to achieve the above object, the present invention includes at least the following features.

The present invention provides an optical surface defect inspection apparatus including: an irradiation means irradiating a subject with an inspection light; a plurality of detecting optical systems detecting a scattered light from a surface of the subject; a processing unit processing an output from each optical receiver in the plurality of detecting optical systems and inspecting for a defect on the surface of the subject based on the processing result; and a storage unit storing therein data processed by the processing unit,

wherein the storage unit stores therein a reference matrix recipe provided with a plurality of feature items indicative of features of the defect on one axis of the matrix and optical items including a range of detected value levels of the plurality of detecting optical systems with respect to the feature items on the other axis, the reference matrix recipe having information defining the defect at a plurality of points in the matrix, and the reference matrix recipe being generated in advance with respect to each of the defects, and

the processing unit determines a type of the defect by creating a work matrix recipe corresponding to the reference matrix recipe based on the output from the plurality of detecting optical systems and comparing the work matrix recipe with the reference matrix recipe.

The present invention also provides an optical surface defect inspection method including the steps of: irradiating a subject with an inspection light; focusing a scattered light from a surface of the subject onto a plurality of optical receivers; and inspecting for a defect on the surface of the subject based on outputs from the optical receivers, the method further including the steps of:

creating in advance and storing therein a reference matrix recipe with respect to each defect, the reference matrix recipe being provided with a plurality of feature items indicative of features of the defect on one axis of the matrix and optical items including a range of detected value levels of the plurality of detecting optical systems with respect to the feature items on the other axis, and the reference matrix recipe having information defining the defect at a plurality of points in the matrix, and

determining a type of the defect by creating a work matrix recipe corresponding to the reference matrix recipe based on the output from the plurality of detectors and comparing the work matrix recipe with the reference matrix recipe.

The present invention can thus provide the optical surface defect inspection apparatus or the optical surface defect inspection method capable of classifying new defects or inspecting more finely classified defects.

### BRIEF DESCRIPTION OF THE DRAWINGS

FIG. 1 shows an embodiment of an optical surface defect inspection apparatus;

FIG. 2 shows a schematic configuration of the present inspection optical system;

FIG. 3 shows a configuration of a first inspection optical system inspecting for a microdefect of the present inspection optical systems;

FIG. 4 shows a configuration of a second inspection optical system inspecting for a shallow defect of the present inspection optical systems;

FIG. 5 shows a procedure for creating a matrix recipe;

FIG. 6 shows the matrix recipe for a particle (foreign object);

FIG. 7 shows the matrix recipe for a bubble;

FIG. 8 shows the matrix recipe for a second defect;

FIG. 9 shows a method of discriminating a defect type using the matrix recipe;

FIG. 10 shows an example of a work matrix recipe for a defect determined as the particle (foreign object) by a reference matrix recipe for the particle (foreign object) shown in FIG. 6;

FIG. 11 shows a method of discriminating a defect type by the work matrix recipe based on data at one or more measuring points;

FIG. 12 shows a conventional method of discriminating the defect type; and

FIG. 13 shows another conventional method of discriminating the defect.

### DESCRIPTION OF THE PREFERRED EMBODIMENTS

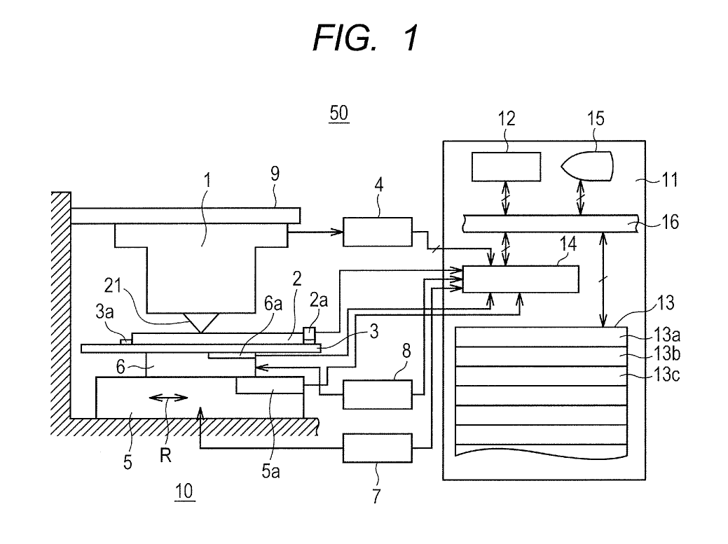

FIG. 1 shows an embodiment of an optical surface defect inspection apparatus (hereinafter, referred to simply as an inspection apparatus) 50 for a magnetic disk and the like. The inspection apparatus includes an inspection optical system 1 irradiating a surface of a work (subject) 2 such as the magnetic disk, a hard disk, and the like to obtain a reflection, a frame 9 supporting the inspection optical system on the apparatus, a scanning unit 10 scanning the hard disk so that the full surface of the hard disk can be scanned, a preprocessing unit 4 processing an output from the inspection optical system and controlling the irradiating light, and a data processing device 11 equipped with a processing unit 12 controlling the scanning unit 10 and inputting the output from the preprocessing unit 4 to process the data.

Hereinbelow, configurations of the inspection optical system 1, the preprocessing unit 4, the data processing device 11, and the scanning unit 10 according to the present embodiment and an inspection method using these configurations will be described in the order with reference to drawings.

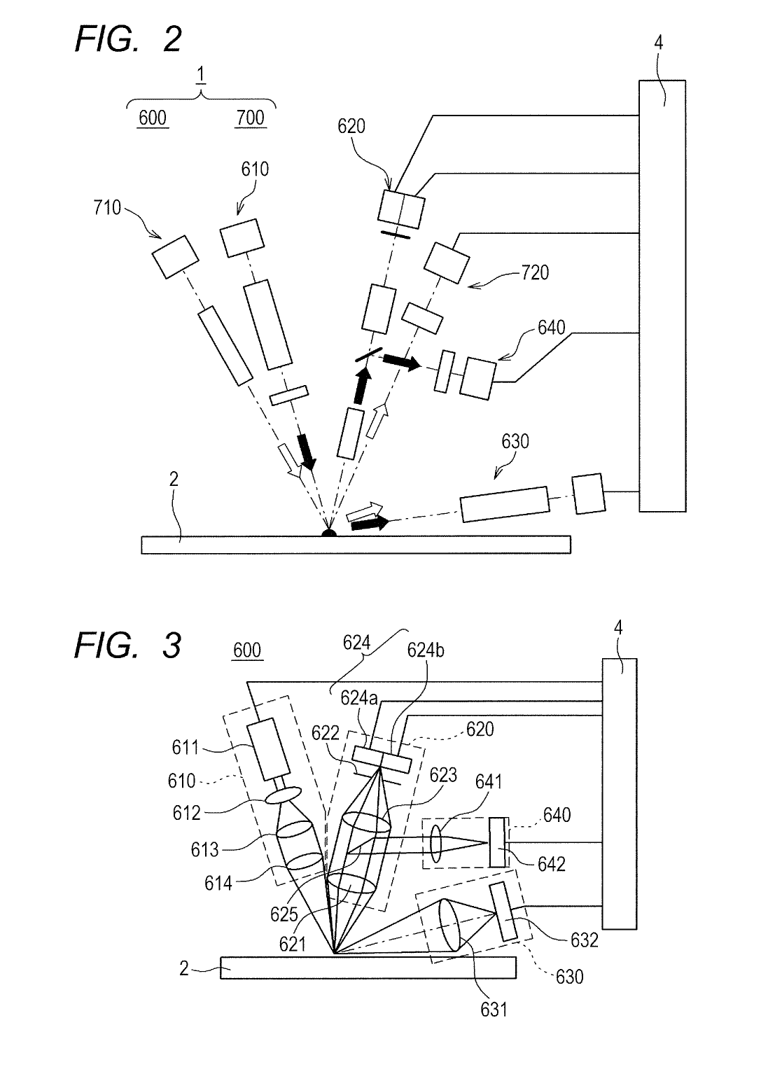

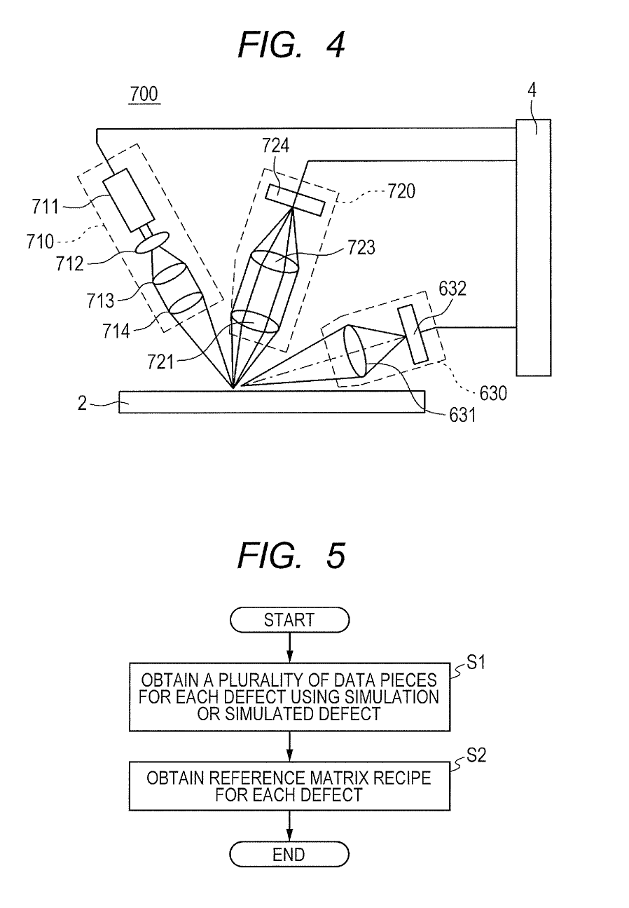

First, the configuration of the inspection optical system 1 as a feature of the embodiment of the present invention will be described with reference to FIGS. 2 to 4. FIG. 2 shows a schematic configuration of the inspection optical system 1. The inspection optical system 1 includes two inspection optical systems; a first inspection optical system 600 inspecting for a microdefect with approximately 20 nm size/width, and a second inspection optical system 700 inspecting for a shallow defect (a scratch defect with a shallow depth). FIG. 3 shows the configuration of the first inspection optical system 600 in more detail. FIG. 4 shows the second inspection optical system 700 in more detail. It should be noted that, in FIG. 2, black and white arrows show relations with an illumination optical system and with a detecting optical system receiving a reflection of an irradiating light therefrom, respectively.

The first inspection optical system 600 shown in FIG. 3 includes a first illumination optical system 610 irradiating the work 2 with an inspection light with a micro-sized diameter (a few nanometers or larger) to detect a microdefect, a first regular reflection light detecting optical system 620 detecting a regular light scattering on a vertical axis side of the work 2, a dark-field detecting optical system 630 detecting a scattered light from a foreign object present on the work 2, and a bright-field detecting optical system 640 detecting a scattered light scattering on a vertical axis side of the work 2.

The first illumination optical system 610 includes a laser light source 611, a beam expanding lens 612 expanding a laser light emitted from the laser light source 611, a collimator lens 613 converting the laser light expanded by the beam expanding lens 612 into a parallel light, and a converging lens 614 converging the parallel laser light with the expanded diameter onto a surface of the work 2.

The first regular reflection light detecting optical system 620 is arranged along an optical axis of a regular reflection light from the work 2 irradiated with the laser light converged by the illumination optical system 610, and includes a condenser lens 621, a beam splitter 625, an imaging lens 623, a slit 622, and a first detector 624. The condenser lens 621 condenses the reflection lights including the regular reflection light and the scattered light from the work 2. The beam splitter 625 distributes the condensed reflection light to the bright-field detecting optical system 640 at a predetermined rate. The imaging lens 623 focuses the reflection light from the condenser lens 621 at a predetermined magnification. The slit 622 shields the scattered light from the work 2 among the reflection light focused by the imaging lens. The first detector 624 detects only the regular reflection light, and two detectors 624a and 624b are included to improve the resolution.

The first regular reflection light detecting optical system 620 detects a defect that hardly causes scattering or diffraction. For example, because an irradiation of a laser light onto a pit defect causes an axis misalignment and a lens effect due to the defect and changes an intensity distribution of the regular reflection light, the first regular reflection light detecting optical system 620 detects a change in the amount of the light passing through the slit 622, thereby detecting the pit defect.

The dark-field detecting optical system 630 includes a condenser lens 631 condensing the laterally scattered light from the work 2 irradiated with the laser light, and a second detector 632 detecting the scattered light condensed by the condenser lens 631.

When the laser light is irradiated onto the foreign object on the work 2, an intense scattered light (diffracted light) is generated from the subject surface and a scattered light is generated from the foreign object, and therefore the dark-field detecting optical system 630 detects a deposited foreign object by capturing the scattered light. Such an intense scattered light from the subject surface like a disk becomes a random diffracted light due to an influence from a polishing trace. A light receiving angle is set low so that the scattered light from the foreign object may hardly be influenced by the diffracted light and that the scattering intensity may easily be received.

The bright-field detecting optical system 640 includes the beam splitter 625 mainly reflecting the scattered light of the reflections light, an imaging lens 641 focusing the scattered light reflected by the beam splitter, and a third detector 642 receiving the focused scattered light.

When the laser light is irradiated onto a flaw such as a scratch or contamination on the subject 2, a scattered diffraction pattern with directivity different from that of a diffraction pattern from a normal surface of the subject is generated, and therefore the bright-field detecting optical system 640 detects the flaw such as the scratch or the contamination by capturing the scattering diffracted light.

On the other hand, the second inspection optical system 700 shown in FIG. 4 includes a second illumination optical system 710, a second regular reflection light detecting optical system 720, and the dark-field detecting optical system 630 shown in FIG. 2 also detecting a reflection from the second illumination optical system 710. The basic components 711 to 714 of the second illumination optical system 710 are identical to the components 611 to 614 of the first illumination optical system 610. The difference between the two is that the second illumination optical system 710 has a larger beam diameter of the irradiating light than that of the first illumination optical system.

The second regular reflection light detecting optical system 720 is arranged along an optical axis of a regular reflection light from the work 2 irradiated with the laser light converged by the illumination optical system 710, and includes a condenser lens 721, an imaging lens 723, and a fourth detector 724. The condenser lens 721 condenses the reflections including the regular reflection light and the scattered light from the subject 2. The imaging lens 723 focuses the reflection light from the condenser lens 621 at a predetermined magnification.

Like the first regular reflection light detecting optical system 620, the second regular reflection light detecting optical system 720 detects a defect that hardly causes scattering or diffraction. When a laser light conforming to the size (width) of the defect is irradiated onto the defect such as a bump and a dimple, the first regular reflection light detecting optical system 620 detects a light/dark pattern of the regular reflection light from the defect, thereby detecting the corresponding defect.

Next, an explanation is given about a mechanism and an operation of a full scanning of the subject surface by spirally scanning the subject 2 in a doughnut shape like a magnetic disk. A work table 3 is, as shown in FIG. 1, supported by a linearly moving table 5 and a θ-rotating table 6. The linearly moving table 5 travels linearly in a direction R, and the θ-rotating table 6 is provided on the linearly moving table 5. The θ-rotating table 6 is provided with an encoder 6a that generates a signal indicative of an angle of rotation, and the linearly moving table 5 is provided with an encoder 5a generating a signal indicative of a moving position in the direction R. The signal from each of the encoders 5a, 6a is transmitted to the data processing device 11 (interface 14) as a scanning position signal. Note that 2a denotes a sensor detecting the fact that the subject 2 is placed on the work table 3. Denoted by 3a is a guide pin for setting the subject 2 so that the center of the doughnut-shaped subject 2 coincides with the center of rotation of the θ-rotating table 6. Denoted by 8 is a θ-direction drive circuit driving the θ-rotating table 6, through which a direction of rotation, a speed of rotation, a stopping position, and the like can be controlled. Denoted by 7 is an R-direction drive circuit moving the linearly moving table 5 linearly in the direction R. These drive circuits are controlled based on a control signal from the data processing device 11.

Such a mechanism enables spiral scanning of the subject according to a constant-speed spiral scanning program 13b stored in a storage unit 13. Specifically, the subject 2 is placed so that the center of the subject 2 coincides with the center of rotation of the θ-rotation table 6, and an inspection light 21 is set to an inner edge of the doughnut. Subsequently, while rotating the work table 3 using the θ-rotation table 6 at a constant speed, the work table 3 is moved by the linearly moving table 5 in the direction of the radius (R) of the subject 2, i.e., in a horizontal direction in FIG. 1. This enables the inspection light 21 to scan the whole surface of the subject 2.

The scanning is not limited to the spiral form, but scanning in a rectangular shape or moving the inspection optical system 1 for scanning is also conceivable.

The measured data of the scattered light at each measuring point in the case of full-surface scanning is converted into a digital value via the preprocessing unit 4 and transferred to the data processing device 11, and each measuring point (scanning) position specified by each encoder 5a, 6a and the measured value at the point are stored in a measurement result storage area 13c of the storage unit 13. A defect analysis program 13a stored in the storage unit 13 makes it possible to analyze the data on each measuring point of which position is recognized, inspect for the foreign object such as a scratch S, and display the result on a display device 15. Note that denoted by 16 in FIG. 1 is a bus.

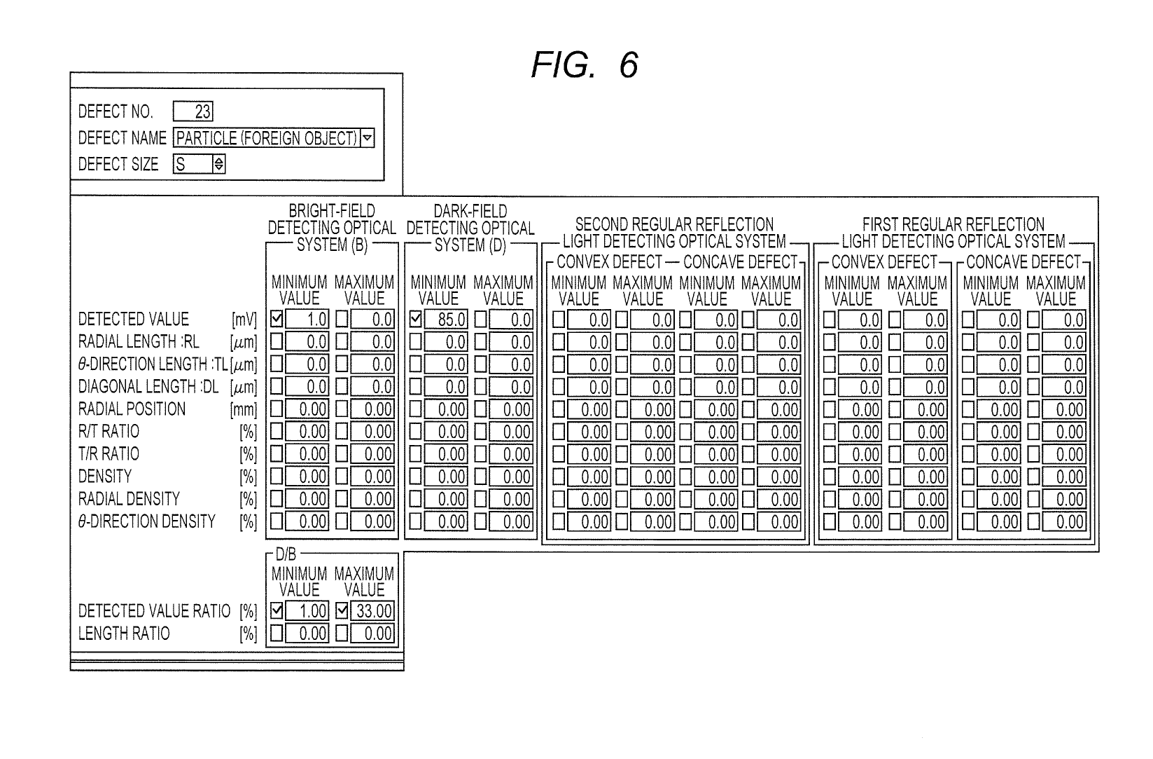

Explained hereinbelow is a defect detection method that characterizes the present invention. FIG. 5 shows a flow of the defect detection method that characterizes the present invention. FIGS. 6 to 8 show examples of the matrix recipe for the defect to be described later in the optical surface defect inspection apparatus shown in FIG. 1.

In this embodiment, the matrix recipe is generated for each defect, and then the subject 2 is inspected using the matrix. FIG. 5 shows a procedure for creating the matrix recipe. First, as shown in FIG. 6, a matrix display is set showing feature items indicative of features of the defect on the ordinate axis and optical items such as ranges (maximum value, minimum value) of the detected value levels of each detecting optical system shown in FIG. 2 on the abscissa axis (S1). The feature item may include a detected value of the detector, a radial length RL of the defect, an angle-θ-direction length TL of the defect, their radial positions, ratio of the radial length and the angle-θ-direction length of the defect RL/TL, or a ratio of detection levels between detectors. The optical item may include geometric items indicative of whether the defect is convex or concave in the first and second regular reflection light detecting optical systems 620, 720 as shown in FIG. 6. It is determined whether the defect is convex or concave by looking at the shape of the detected signal. Although the first regular reflection light detecting optical system 620 includes two detectors in this embodiment, there is one inspection item, and therefore the abscissa axis has six inspection items for four inspection light optical systems.

Next, for each defect, a plurality of data pieces that can be obtained using a simulation or a simulated defect are sorted on the matrix shown in FIG. 6 to obtain information for defining each defect at a plurality of points in the matrix (S2). The matrix type information obtained for each defect is referred to as a matrix recipe. The matrix recipe in this embodiment has a check mark on an item corresponding to the matrix point defining each defect.

The matrix recipe shown in FIG. 6 relates to a particle (foreign object). The particle in this embodiment is defined by two feature items on two detecting optical systems indicated by three check marks. In other words, a detected value level B of the bright-field detecting optical system 640 is 1 mV or higher, a detected value level D of the dark-field detecting optical system 630 is 85 mV or higher, and a ratio between them is 1 to 33. If these conditions are satisfied, the defect is determined to be a particle.

If, for example, many particles are found and they are characterized by their positions of generation, the positions are entered as a radial position. By doing so, it is possible to grasp a problem in the production process of the subject 2. Furthermore, for example, different matrix recipes by the size level such as large, medium, and small may be prepared depending on the detected value level D of the dark-field detecting optical system 630 or the D/B of the both. Thus, the fine classification can be facilitated depending on the purpose and the problem in the production process can be grasped.

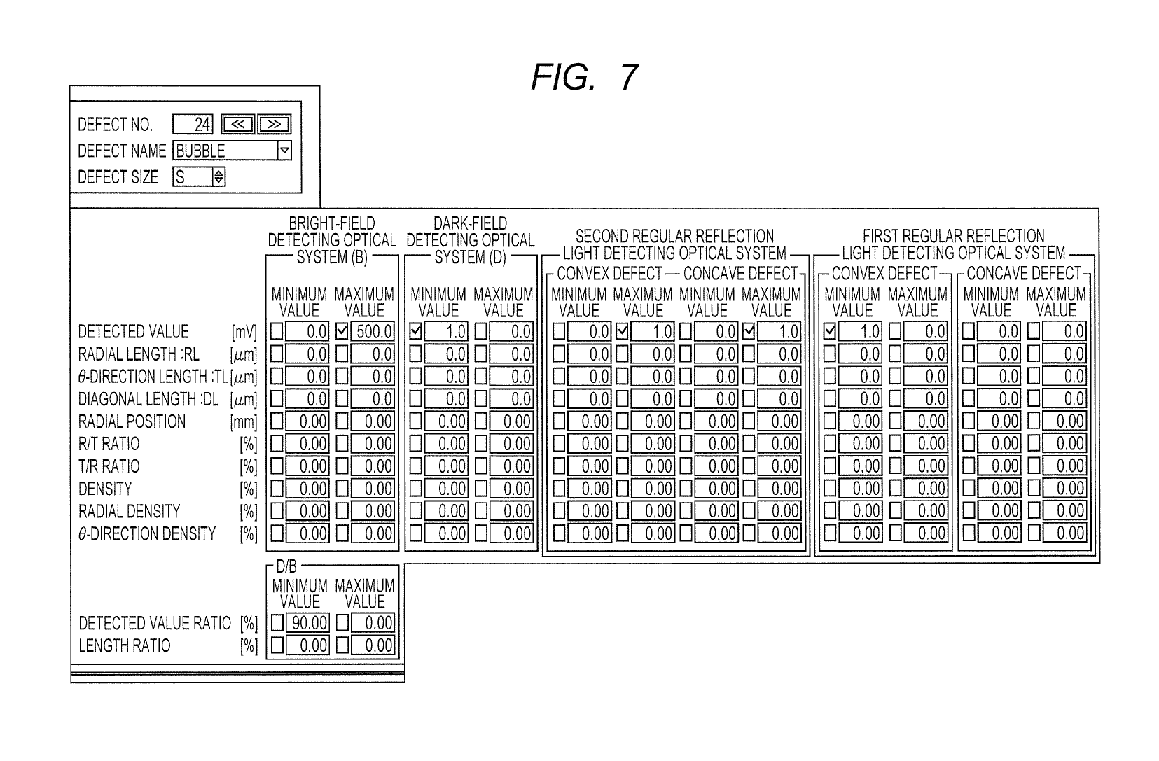

The matrix recipe shown in FIG. 7 relates to a bubble (bubble in the subject). The bubble in this embodiment is defined by four feature items on four detecting optical systems indicated by four check marks. In other words, a weak scattered light signal is detected in which firstly the detected value level B of the bright-field detecting optical system 640 is 500 mV or lower and secondly the detected value level D of the dark-field detecting optical system 630 is 1 mV or higher. Thirdly, the convex defect item of the second regular reflection light detecting optical system 720 indicates 1 mV or lower, which can hardly be detected. Fourthly, a significant value of 1 mV or higher is indicated in the concave geometric item of the second regular reflection light detecting optical system 720 and the convex defect item of the first regular reflection light detecting optical system 620, especially in the convex defect item of the first regular reflection light detecting optical system 620. If these conditions are satisfied, the defect is determined to be a bubble.

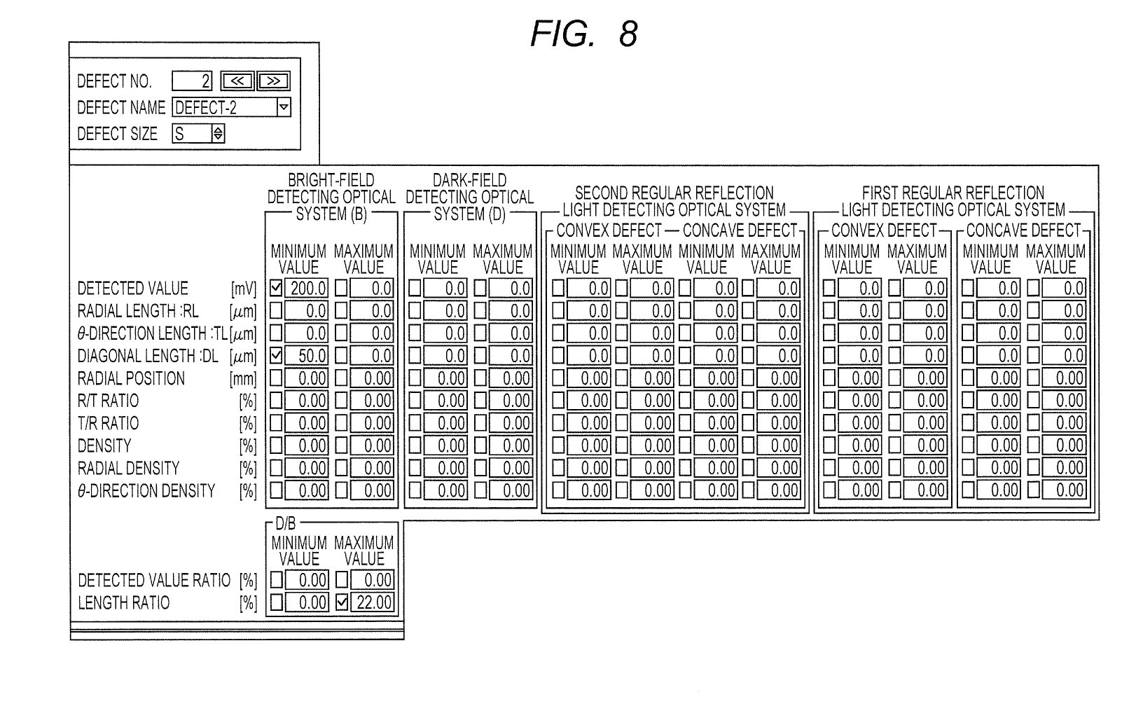

The matrix recipe shown in FIG. 8 relates to a second defect (defect name defined by a user). The second defect in this embodiment is defined by three feature items detected by the bright-field detecting optical system 640 indicated by three check marks. In other words, almost no value is detected except from the bright-field detecting optical system 640. The detected value level B of the bright-field detecting optical system 640 is 500 mV or lower, the diagonal length DL having its component in the radial direction and the angle-θ direction is 50 mm or longer, and the ratio BDL/DDL between the diagonal length BDL and the diagonal length DDL detected by the dark-field detecting optical system is 22 or higher. If these conditions are satisfied, the defect is determined to be the second defect.

As described above, the reference matrix recipe for comparison with each defect is prepared in advance.

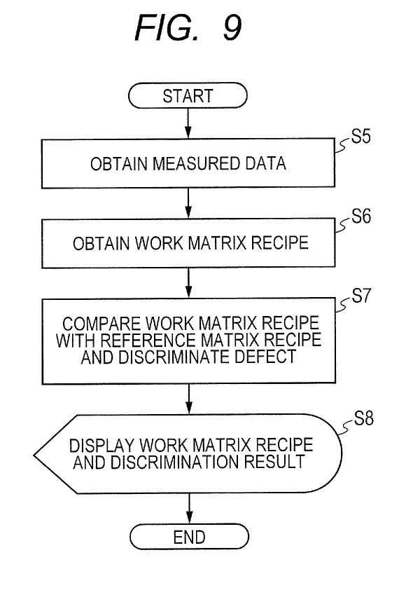

FIG. 9 shows a method of discriminating a defect using such a matrix recipe.

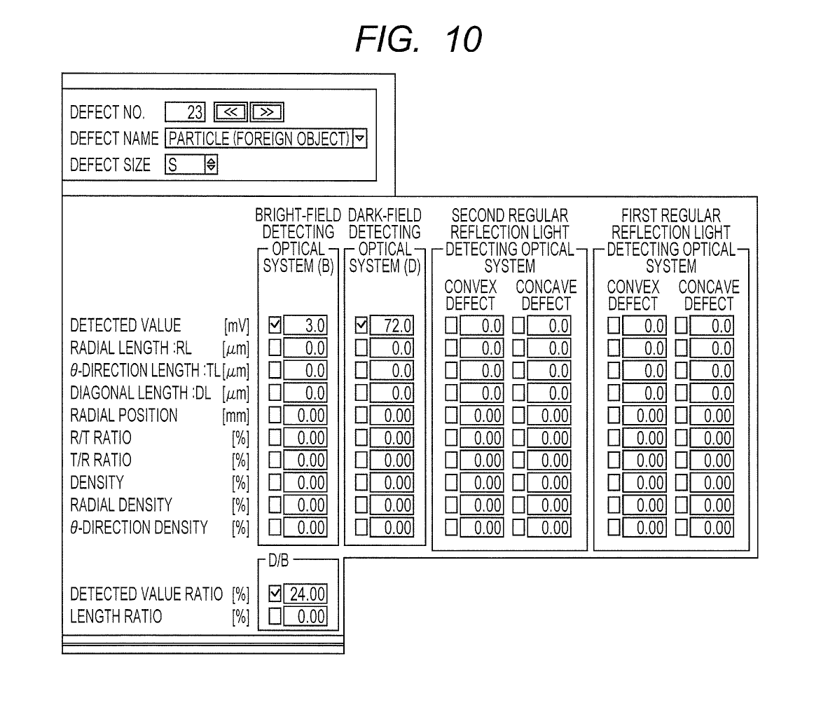

First, the measured data is obtained at each point while moving the subject 2 (S5). The work matrix recipe corresponding to the reference matrix recipe is obtained by processing the data (S6). FIG. 10 shows an example of the work matrix recipe for the defect determined as the particle (foreign object) by the reference matrix recipe for the particle (foreign object) shown in FIG. 6. In this example, there is no maximum value and minimum value items which are optical items in the reference matrix recipe but only rows for entering numeral values obtained from the corresponding defect are prepared. Furthermore, there is no need of storing the data in a form of a matrix but the information of significant data may be stored along with an address in the matrix.

It should be noted that not all the feature items must be processed because some feature items may not include any data and some feature items are less necessary.

Next, the defect is determined by comparing the obtained work matrix recipe with the reference matrix recipe (S7), and the work matrix recipe is displayed on the display device 15 (S8).

When the inspection is performed by the lot unit, the feature items are narrow down the items by which that the feature of a defect comes out, the other items may be deleted.

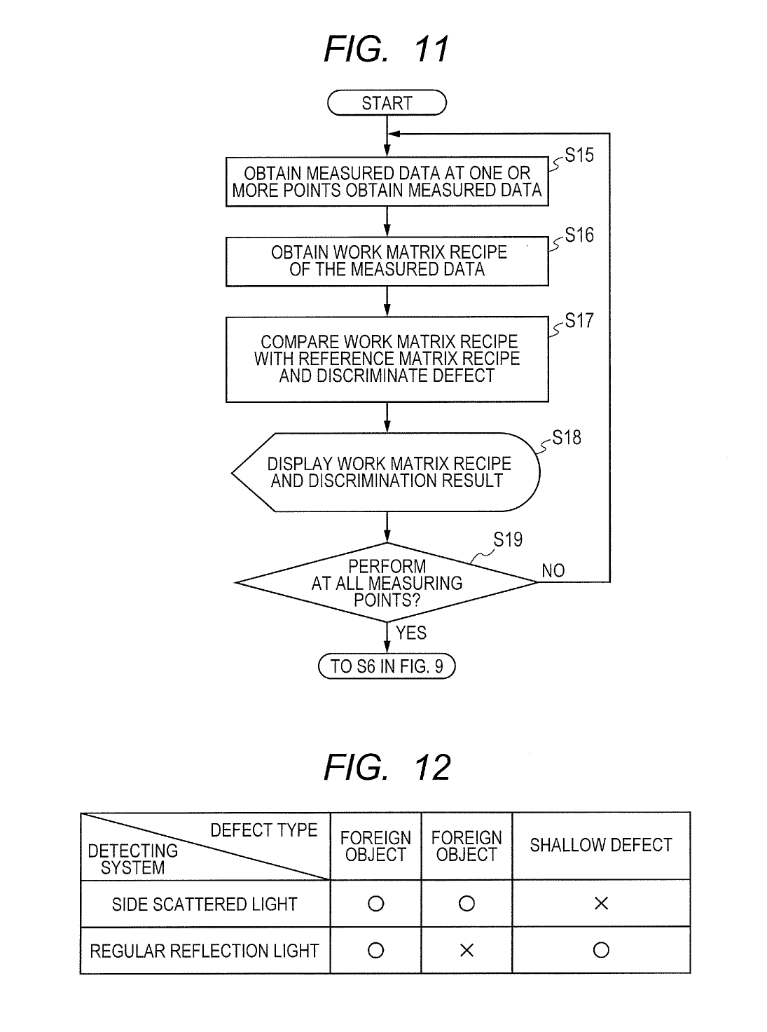

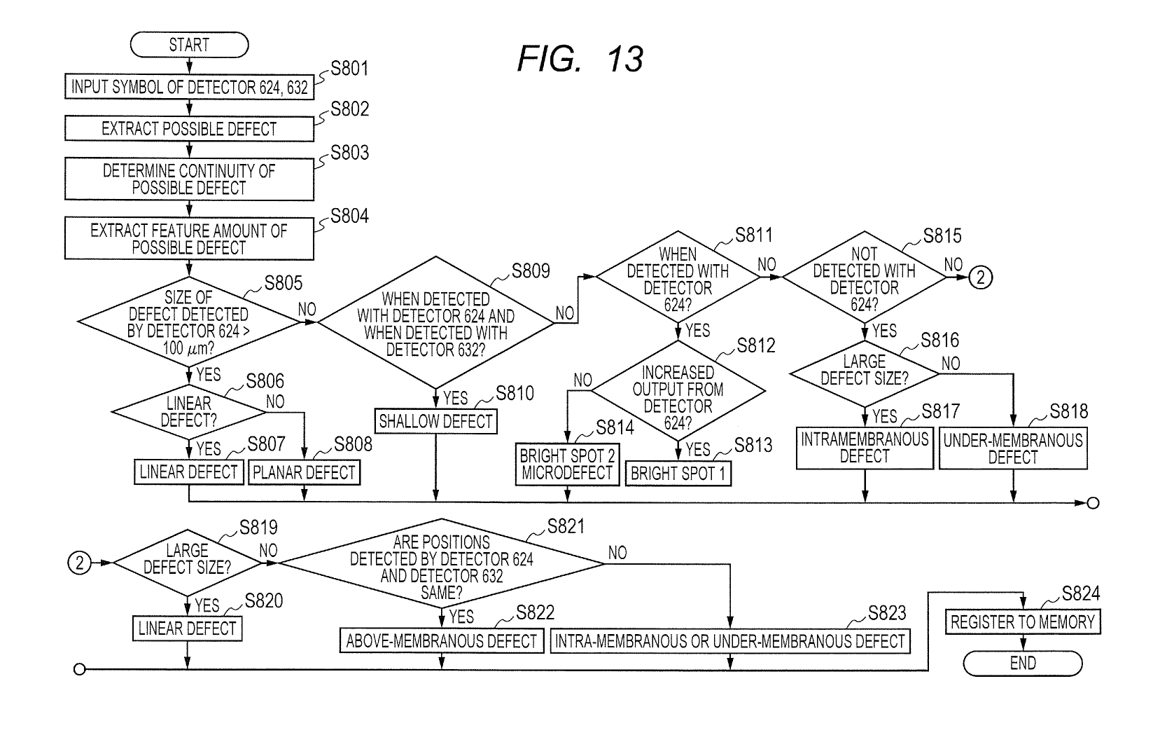

In FIG. 9, after obtaining the data at all points on the subject 2, the work matrix recipe and the reference matrix recipe are compared to discriminate the defect. In FIG. 11, for example, when there are few feature items and the data is obtained at one or more measuring points (S15), the work matrix recipe for the obtained measuring point is obtained (S16), and which can discriminate primarily performs tentatively (S17). The process then proceeds to S6 shown in FIG. 9, where in addition to the detailed data such as the position of the defect, the length of the defect, and the like, the defect with the primary discrimination are discriminated while referring to the primary discrimination, other defects are directly discriminated based on the detailed data.

Furthermore, as explained with reference to FIG. 6, the inspection efficiency may be improved by more finely classifying frequent generating defects for the inspection.

Moreover, instead of obtaining data on many feature items from the beginning as shown in FIG. 6, the feature items may be added based on the inspection result and the resulting data may be reprocessed for the inspection. Especially adding the feature items such as the defect position and the length can facilitate an investigation for the cause of the defect in the production process, which will contribute to a later improvement of the production yield.

In this manner, the inspection using the matrix recipe allows for easy addition, deletion, or fine classification of a feature item, enabling an inspection with high degree of freedom.

What is claimed is:

1. An optical surface defect inspection apparatus including: an irradiation means irradiating a subject with an inspection light; a plurality of detecting optical systems detecting a scattered light from a surface of the subject; a processing unit processing an output from each optical receiver in the plurality of detecting optical systems and inspecting for a defect on the surface of the subject based on the processing result; and a storage unit storing therein data processed by the processing unit,
wherein the storage unit stores therein a reference matrix recipe provided with a plurality of feature items indicative of features of the defect on one axis of the matrix and optical items including a range of detected value levels of the plurality of detecting optical systems with respect to the feature items on the other axis, the reference matrix recipe having information defining the defect at a plurality of points in the matrix, and the reference matrix recipe being created in advance with respect to each of the defects, and
the processing unit determines a type of the defect by creating a work matrix recipe corresponding to the reference matrix recipe based on the output from the plurality of detecting optical systems and comparing the work matrix recipe with the reference matrix recipe.

2. The optical surface defect inspection apparatus according to claim 1, wherein the plurality of detecting optical systems respectively include a bright-field detecting optical system, a dark-field detecting optical system, and a regular reflection light detecting optical system.

3. The optical surface defect inspection apparatus according to claim 1, wherein the irradiation means includes a plurality of irradiation means with different irradiation sizes.

4. The optical surface defect inspection apparatus according to claim 2, wherein the irradiation means includes a plurality of irradiation means with different irradiation sizes.

5. The optical surface defect inspection apparatus according to claim 1, wherein the feature item can be more finely classified, deleted, or added.

6. The optical surface defect inspection apparatus according to claim 2, wherein the feature item can be more finely classified, deleted, or added.

7. The optical surface defect inspection apparatus according to claim 3, wherein the feature item can be more finely classified, deleted, or added.

8. The optical surface defect inspection apparatus according to claim 1, further including:
a display device displaying at least one of the reference matrix recipe, the work matrix recipe, and the determination result.

9. The optical surface defect inspection apparatus according to claim 2, further including:
a display device displaying at least one of the reference matrix recipe, the work matrix recipe, and the determination result.

10. The optical surface defect inspection apparatus according to claim 3, further including:
a display device displaying at least one of the reference matrix recipe, the work matrix recipe, and the determination result.

11. The optical surface defect inspection apparatus according to claim 4, further including:
a display device displaying at least one of the reference matrix recipe, the work matrix recipe, and the determination result.

12. The optical surface defect inspection apparatus according to claim 5, further including:
a display device displaying at least one of the reference matrix recipe, the work matrix recipe, and the determination result.

13. An optical surface defect inspection method including the steps of: irradiating a subject with an inspection light; focusing a scattered light from a surface of the subject onto a plurality of optical receivers; and inspecting for a defect on the surface of the subject based on outputs from the optical receivers, the method further including the steps of:
creating in advance and storing therein a reference matrix recipe with respect to each defect, the reference matrix recipe being provided with a plurality of feature items indicative of features of the defect on one axis of the matrix and optical items including a range of detected value levels of the plurality of detecting optical systems with respect to the feature items on the other axis, and the reference matrix recipe having information defining the defect at a plurality of points in the matrix, and
determining a type of the defect by creating a work matrix recipe corresponding to the reference matrix recipe based on the output from the plurality of detectors and comparing the work matrix recipe with the reference matrix recipe.

14. The optical surface defect inspection method according to claim 13, wherein the plurality of detecting optical systems respectively include a bright-field detecting optical system, a dark-field detecting optical system, and a regular reflection light detecting optical system.

15. The optical surface defect inspection method according to claim 13, wherein the reference matrix recipe is obtained from a plurality of data pieces obtained using a simulation or a simulated defect.

16. The optical surface defect inspection method according to claim 14, wherein the reference matrix recipe is obtained from a plurality of data pieces obtained using a simulation or a simulated defect.

17. The optical surface defect inspection method according to claim 13, further including the steps of:
more finely classifying, deleting, or adding the feature item.

18. The optical surface defect inspection method according to claim 14, further including the steps of:
more finely classifying, deleting, or adding the feature item.

19. The optical surface defect inspection method according to claim 15, further including the steps of:
more finely classifying, deleting, or adding the feature item.

20. The optical surface defect inspection method according to claim 13, further including the steps of:
displaying at least one of the reference matrix recipe, the work matrix recipe, and the determination result.
